(19) United States
(12) Patent Application Publication
(10) Pub. No.: US 2008/0297296 A1
(43) Pub. Date: Dec. 4, 2008

(54) TRANSFORMER AND INSULATING COVER THEREOF

(76) Inventors: Hui-Hua TENG, Taoyuan Hsien (TW); Chen Feng Wu, Taoyuan Hsien (TW)

Correspondence Address: BIRCH STEWART KOLASCH & BIRCH, PO BOX 747, FALLS CHURCH, VA, 22040-0747, US

(21) Appl. No.: 11/971,731

(22) Filed: Jan. 9, 2008

(30) Foreign Application Priority Data
May 31, 2007 (TW) 096119484

(51) Int. Cl. H01F 27/02

(52) U.S. Cl. 336/98

(57) ABSTRACT

A transformer includes a bobbin, a first winding, a second winding, a core set and an insulating cover. The bobbin has a first winding area and a second winding area. The first winding and the second winding are wound around the first and second winding areas of the bobbin, respectively. The core set surrounds the first winding and the second winding. The insulating cover covers the bobbin and completely covers the core set except inserting sides of the core set.

### CROSS REFERENCE TO RELATED APPLICATIONS

This Non-provisional application claims priority under 35 U.S.C. §119(a) on Patent Application No. 096119484 filed in Taiwan, Republic of China on May 31, 2007, the entire contents of which are hereby incorporated by reference.

### BACKGROUND OF THE INVENTION

1. Field of Invention

The invention relates to a transformer and, in particular, to a transformer having an insulating cover that completely covers a core set.

2. Related Art

As shown in FIGS. 1 and 2, a conventional transformer I includes a bobbin 11, a core set 13 and a top cover 14. The bobbin 11 has a primary winding area 111, a secondary winding area 112 and a through hole 113. A primary winding 121 is wound around the primary winding area 111, and a secondary winding 122 is wound around the secondary winding area 112. The top cover 14 covers one side of the bobbin 11. The core set 13 consists of two iron cores disposed opposite to each other and going through the through hole 113 of the bobbin 11.

However, the insulation of the transformer 1 is carried out by the top cover 14 covering the core set 13. Both ends of the core set 13 are exposed outside of the top cover 14. To ensure a sufficient safety distance between the core set 13 and the pins of the windings 121 and 122, the size of the bobbin 11 has to be increased. Therefore, the size of the transformer 1 cannot be further reduced and is thus unsuitable for miniaturization. Moreover, the design of the top cover 14 cannot effectively prevent the core set 13 from the interference of other electronic devices. Therefore, this structure can not meet the safety requirements.

Therefore, it is an important subject to provide a transformer and an insulating cover thereof to prevent the core set from being exposed to the environment, thereby preventing the core set from the interference of other electronic devices so as to meet the safety requirements.

### SUMMARY OF THE INVENTION

In view of the foregoing, an object of the invention is to provide a transformer and an insulating cover thereof to prevent the core set from being exposed to the environment, thereby preventing the core set from the interference of other electronic devices so as to meet the safety requirements and miniaturization design.

To achieve the above, the invention discloses a transformer including a bobbin, a first winding, a second winding, a core set and an insulating cover. The bobbin has a first winding area and a second winding area. The first winding is wound around the first winding area, and the second winding is wound around the second winding area. The core set surrounds the first winding and the second winding. The insulating cover covers the bobbin and completely covers the core set.

In addition, the invention also discloses an insulating cover used in a transformer. The transformer has a bobbin, a first winding, a second winding and a core set. The first winding and the second winding are wound around a first winding are and a second winding area of the bobbin, respectively, and the core set surrounds the first winding and the second winding. The insulating cover includes a body and an extension structure. The body covers the bobbin and the core set, while the core set has an exposed part. The extension structure covers the exposed part of the core set except inserting sides of the core set.

As mentioned above, the transformer and the insulating cover of the invention use the extension structure connected with the body to cover the exposed part of the core set. In comparison with the related art, the invention can effectively insulate the core set from the environment and thus the surrounding devices so as to satisfy the safety requirements. Moreover, the design of the insulating cover of the invention effectively reduces the size of the transformer, as demanded by the miniaturization trend.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is an exploded view of a conventional transformer;

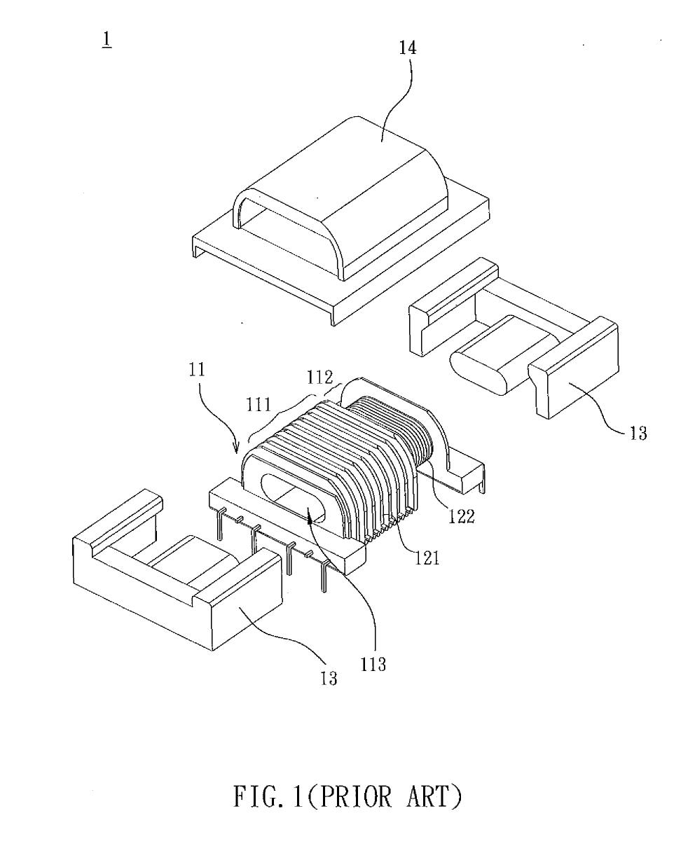

FIG. 2 is an assembly diagram of the transformer in FIG. 1;

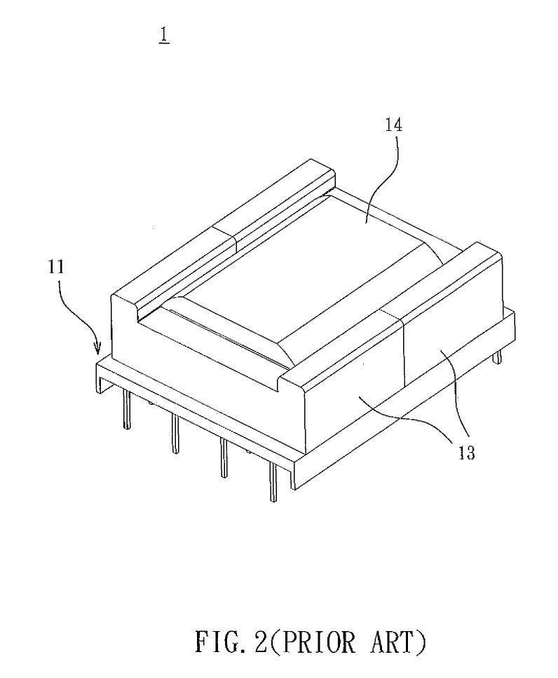

FIG. 3 is an exploded view of a transformer according to an embodiment of the invention; and

FIG. 4 is a schematic view of the assembled transformer of FIG. 3.

### DETAILED DESCRIPTION OF THE INVENTION

The present invention will be apparent from the following detailed description, which proceeds with reference to the accompanying drawings, wherein the same references relate to the same elements.

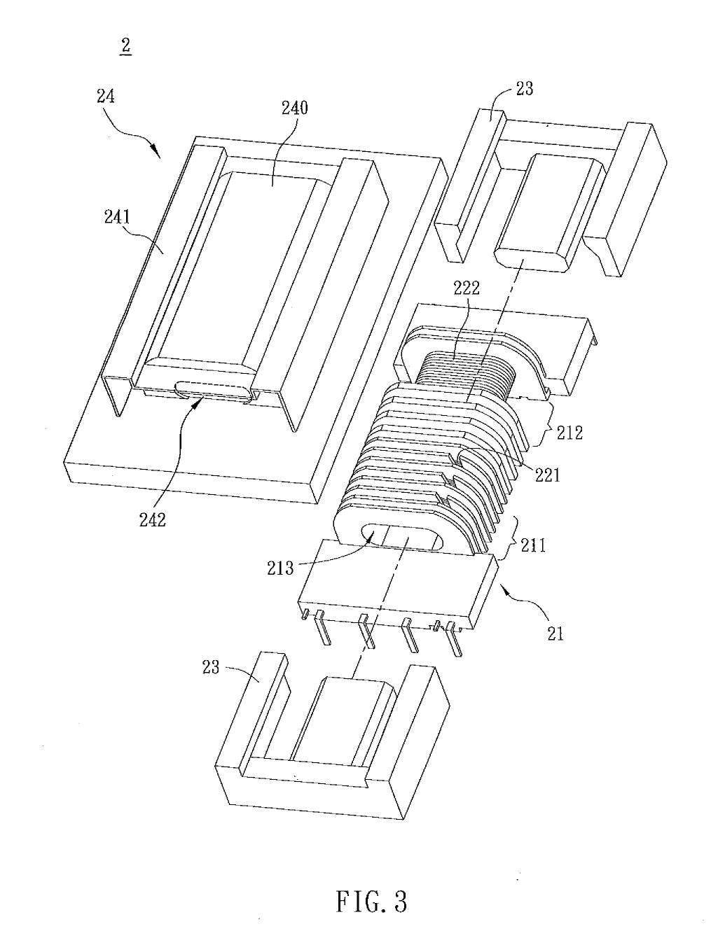

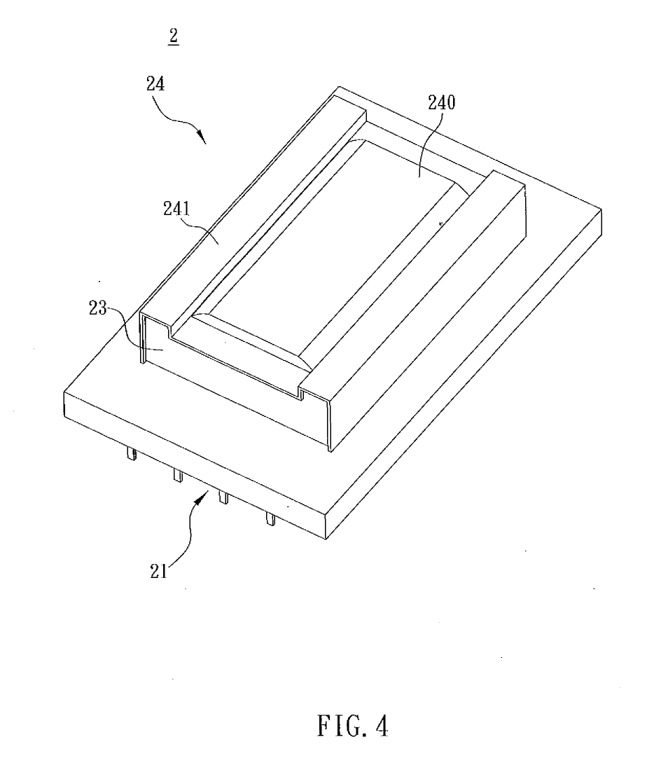

Please refer to FIGS. 3 and 4. A transformer 2 according to an embodiment of the invention includes a bobbin 21, two sets of windings 221, 222, a core set 23 and an insulating cover 24. The bobbin 21 has two winding areas 211, 212 and a through hole 213. The winding 221 is wound around the winding area 211 and functions as a primary winding or a voltage input terminal. The winding 222 is wound around the winding area 212 and functions as a secondary winding or a voltage output terminal. Alternatively, in practice, the winding 221 can be a secondary winding and the winding 222 can be a primary winding. The core set 23 consists of at least two iron cores connected together and surrounds the windings 221 and 222. In this embodiment, the core set 23 is an EFD-type core set. Alternatively, the core set 23 can be an EE-type core set, an EF-type core set, an EI-type core set, an EC-type core set, an EER-type core set an ETD-type core set, a UI-type core set, or an EPC-type core set.

The insulating cover 24 includes a body 240 and an extension structure 241. The body 240 has a through hole 242. The body 240 and the extension structure 241 can be formed as a single unit by using injection molding, pressure molding or casting molding. Besides, the body 240 and the extension structure 241 can be separately prepared and combined together later. The material of the body 240 and the extension structure 241 can be an insulating material, such as plastics, ceramics, or other heatproof material, that is capable of withstanding high temperatures up to 130° C. Moreover, the shape of the extension structure 241 can correspond to that of the core set 23. Alternatively, the extension structure 241 can cover the core set 23, and the shape of the extension structure 241 does not correspond lo that of the core set 23.

The transformer 2 can be assembled in the following manner. First, the windings 221 and 222 are wound around the bobbin 21, which is then covered by the insulating cover 24. In this case, the body 240 covers the bobbin 21 and the windings 221 and 222. The through hole 242 of the body 240 and the through hole 213 of the bobbin 21 are aligned. Afterwards, the core set 23 is disposed in the insulating cover 24 along the space thereof and surrounds the bobbin 21. Herein, the core set 23, except the inserting side thereof, is all covered by the body 240 and the extension structure 241 of the insulating cover 24, so that the core set 23 has only an exposed part on the inserting side. Therefore, the core set 23 and the windings 221, 222 of the bobbin 21 are insulated. Since the extension structure 241 covers a part of the core set 23, it separates the core set 23 from the windings 221 and 222. This structure can effectively insulate the core set from other surrounding devices.

In summary, the transformer and the insulating cover of the invention use the extension structure connected with the body to cover the exposed part of the core set. In comparison with the related art, the invention can effectively insulate the core set from the environment and thus the surrounding devices so as to satisfy the safety requirements. Moreover, the design of the insulating cover of the invention effectively reduces the size of the transformer, as demanded by the miniaturization trend.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A transformer comprising:
a bobbin having a first winding area and a second winding area;
a first winding wound around the first winding area;
a second winding wound around the second winding area;
a core set surrounding the first winding and the second winding; and
an insulating cover covering the bobbin and completely covering the core set except inserting sides of the core set.

2. The transformer of claim 1, wherein the insulating cover comprises:
a body covering the bobbin and the core set, wherein the core set has an exposed part; and
an extension structure covering the exposed part of the core set.

3. The transformer of claim 2, wherein the extension structure and the body are formed as a single unit.

4. The transformer of claim 3, wherein the extension structure and the body are formed as a single unit by injection molding, pressure molding or cast molding.

5. The transformer of claim 2, wherein the material of the body and the extension structure is an insulating material.

6. The transformer of claim 5, wherein the insulating material is capable of withstanding a temperature over 130° C.

7. The transformer of claim 5, wherein the insulating material is plastic or ceramic.

8. The transformer of claim 2, wherein each of the body and the bobbin has a through hole, and the core set goes through the through holes.

9. The transformer of claim 2, wherein a shape of the extension structure corresponds to a shape of the core set.

10. The transformer of claim 1, wherein the core set comprises least two iron cores.

11. The transformer of claim 1, wherein the core set is an EE-type core set, an EF-type core set, an EI-type core set an EC-type core set, an EER-type core set, an ETD-type core set, a UI-type core set, an EPC-type core set, or an EFD-type core set.

12. The transformer of claim 1, wherein the first winding and the second winding are a primary winding and a secondary winding to function as a voltage input terminal and a voltage output terminal, respectively.

13. An insulating cover used in a transformer having a bobbin, a first winding, a second winding and a core set, wherein the first winding and the second winding are wound around a first winding area and a second winding area of the bobbin, respectively, and the core set surrounds the first winding and the second winding, the insulating cover comprising:
a body covering the bobbin and the core set, wherein the core set has an exposed part; and
an extension structure covering the exposed part of the core set.

14. The insulating cover of claim 13, wherein the extension structure and the body are formed as a single unit.

15. The insulating cover of claim 14, wherein the extension structure and the body are formed as a single unit by injection molding, pressure molding or cast molding.

16. The insulating cover of claim 13, wherein the material of the body and the extension structure is an insulating material.

17. The insulating cover of claim 16, wherein the insulating material is capable of withstanding a temperature over 130° C.

18. The insulating cover of claim 16, wherein the insulating material is plastic or ceramic.

19. The insulating cover of claim 13, wherein each of the body and the bobbin has a through hole, and the core set goes through the through holes.

20. The insulating cover of claim 13, wherein a shape of the extension structure corresponds to a shape of the core set.
